(19) United States
(12) Patent Application Publication
(10) Pub. No.: US 2015/0021121 A1
(43) Pub. Date: Jan. 22, 2015

(54) Wrapped Hydraulic Elevator Suspension Machine

(71) Applicant: Carl Thomas Sturdivant, Charlotte, NC (US)

(72) Inventor: Carl Thomas Sturdivant, Charlotte, NC (US)

(21) Appl. No.: 14/040,992

(22) Filed: Sep. 30, 2013

Related U.S. Application Data
(60) Provisional application No. 61/957,945, filed on Jul. 16, 2013.

(51) Int. Cl. B66B 9/04

(52) U.S. Cl. CPC B66B 9/04
USPC 187/253

(57) ABSTRACT

A “Linear Motion Elevator Suspension Machine” in which motion is achieved using Linear Mechanical Actuators, a mechanical device that converts energy to power from air, electricity or liquid, creating motion in a straight line; and is used in this application as a force for lifting a vertically travelling elevator. Consisting of an arrangement of cables and pulleys, which trade force for distances, and driven by an Integrated Power Unit, in which to raise the car, and operate the doors; sequentially, applied to the linear actuators in a manner which is well known and therefore need not be described further in its description.

An integral auxiliary Hydraulic Actuator, with linear or rotor motion “(Car Top Arraignment Only)”, attached to the Frame, and the Door Header, and serves as a Door Operating Device for the opening and closing of the Elevator Car Doors, wherefore, eliminating the needs for traditional motors and door operators.

### CROSS-REFERENCE TO RELATED APPLICATIONS

Provisional Application; US 61/957,945 Tuesday, Jul. 16, 2013

### BACKGROUND OF THE INVENTION

### Field of Invention

The present invention relates to a suspension arrangement for “Roped Hydraulic Elevators”, of which the car is suspended on a rope and indirectly driven by a hydraulic jack/s.

Standard industry designs for roped hydraulic elevators are to use a single cylinder located off center of the elevator frame's cross-head, or dual cylinders located on opposite sides of elevator. In either arrangement, “single or dual cylinders”, a sheave is mounted on top of pistons, allowing the ropes to pass over, in which the ropes are connected to the elevator's frame on one side and to the base of the cylinder on the other. These type rope arrangements produce a 2:1 ratio of elevator travel to jack travel. U.S. Pat. No. 5,238,087 discloses a Roped Hydraulic Elevator. A car and a counterweight are attached to opposite ends of a rope, which is entrained over an idler sheave at the top of the elevator shaft.

In U.S. Pat. No. 5,653,311, the bottom of the jack cylinder is secured to the guide rails. This roping system provides a 3:1 ratio between jack movement and car movement. However, the above propose units possess modern design issues; (1) in all roped hydraulic installations, a separate “Machine Room” space is required to house the Power Units and Controllers; (2) The units require massive pumps and motors to produce the horsepower required to move the massive jacks; (3) some require counterweights to aid in the lifting capacity of the elevator; (4) are limited in height and speed capacity, to that of Electric Traction Elevators; (5) The “Work Factor” or “Force Times Distance Formula is equal to that of the Distance Traveled and the Speed Desired wherefore requiring a higher Power Factor to operate the lift.

These Roped Hydraulic Elevators is limited in its applications to reduce space, power requirements, and the carbon footprint of modern Green Building designs.

It would be desirable to provide a Linear Motion Machine consisting of reduced stroke cylinders, a solid unit with integrated power units and door operators, and simpler in design.

### BRIEF SUMMARY OF THE INVENTION

This present invention is a solid unit, linear motion elevator suspension drive device in which the ropes are wrapped through multiple sheaves driven by hydraulic actuators. This present invention's design objectives, will address limitations in respect to the field of Roped Hydraulic Elevators, as well as the designs in the above fields proposals; (1) A single solid unit encompassing its own power unit, and eliminating the need for a separate Machine Room space; (2) Reducing the needs of horsepower required to move the lift; (3) Eliminates the need for Counterweights to aid in the lifting capacity of the Elevator; (4) Unlimited in height, and speed capacity, to that of Electric Traction Elevators. (5) This Machine reduces the “Work Factor” by a minimum of 90% to that of the distance traveled and the speed desired by dividing the length of work by a factor of at least 12, thus reducing the Power Factor to operate the lift.

This present invention is a single compact machine that houses the complete lifting apparatus including power unit, wherefore, reducing the carbon footprint by 95% to that of a conventional Elevator Machine. The machine exceeds any and all limitations to the current standard industry Roped Hydraulic Elevator in all applications; it includes a framed housing, multiple wraps of cable, through multiple sheaves, on two separate reels, and linear actuator/s capable of pushing the reels apart for raising the elevator and bringing the reels together for lowering the elevator. The machine's design allows the wraps of cable to absorb the weight of the load while the sheaves moves the wraps of cable at a rate of speed and distance, times the number of wraps, to raise the elevator with minimum work and maximum speed.

Driven by an “Integrated Power Unit”. The machine consists of a pair of joined spaced frame members 1, for its housing and containing all apparatus of its embodiment.

An “Integrated Power Unit 2”, in order to raise the car, or operate the doors; is applied to the linear actuators in a manner which is well known and therefore need not be described further in its description.

### BRIEF DESCRIPTION OF THE SEVERAL VIEWS OF THE DRAWING

FIGS. 1 through 9 are views showing an embodiment of the present invention.

FIG. 1 shows a Front or Rear View, Single Stage, Retracted Cylinder, Cross-Head or Under-Slung Mounted, Lift at Bottom of Travel, with 2:1 roping scheme.

FIG. 2 is showing same as FIG. 1) with Extended Cylinder, Lift at Top of Travel.

FIG. 3 shows a Front or Rear View, Multi Stage, Retracted Cylinder, Cross-Head or Under-Slung Mounting, Lift at Bottom of Travel, with 2:1 roping scheme.

FIG. 4 is showing same as FIG. 3) with Extended Cylinder, Lift at Top of Travel.

FIG. 5 shows a Front or Rear View, Multi Stage, Extended Cylinder, Car Operating Panel (COP) Mounting, Lift at Top of Travel, with 1:1 roping scheme.

FIG. 6 shows a Front or Rear View, Multi Stage, Extended Cylinder, Shaft Mounting, Horizontal Position, Lift at Top of Travel, with 2:1 roping scheme.

FIG. 7 shows a Front or Rear View, Multi Stage, Extended Cylinder, Shaft Mounting, Vertical Position, Lift at Top of Travel, with 1:1 roping scheme.

FIG. 8 shows an optional auxiliary Door Operation, Extended Cylinder, Doors Closed, “possible with car mounting only”.

FIG. 9 shows a Front or Rear Viewing, Single Stage, Extended Cylinder, Shaft, or Car, Mounting, Lift at Top of Travel, with 1:1 roping scheme.

### DETAILED DESCRIPTION OF THE INVENTION

“This application claims the benefit of U.S. Provisional Application No. 61/957,945, filed on Tuesday, Jul. 16, 2013”.

Titled a “Linear Motion Elevator Suspension Machine”, to operate an Elevator.

A “Linear Motion Elevator Suspension Machine” in which motion is achieved using Linear Mechanical Actuators, a mechanical device that converts energy to power from air, electricity or liquid, creating motion in a straight line; and is used in this application as a force for lifting a vertically travelling elevator. Consisting of an integrated power unit, multiple wraps of ropes arranged on separate sheaves, driven by Linear Actuator/s capable of pushing the sheaves apart for raising the lift and bringing the sheaves together for lowering the lift.

This machine includes a framed housing, multiple wraps of cable, through multiple sheaves, on two separate reels, and linear actuator/s capable of pushing the reels apart for raising the elevator and bringing the reels together for lowering the elevator. The machine is designed so the wraps of cable will absorb the weight of the load while the sheaves moves the wraps of cable at a multiple rate of speed and distance times the number of wraps, to raise the elevator with minimum work and maximum speed.

This design simulates a block and tackle arrangement of cables and pulleys, which trade force for distance, while driven by an “Integrated Power Unit”.

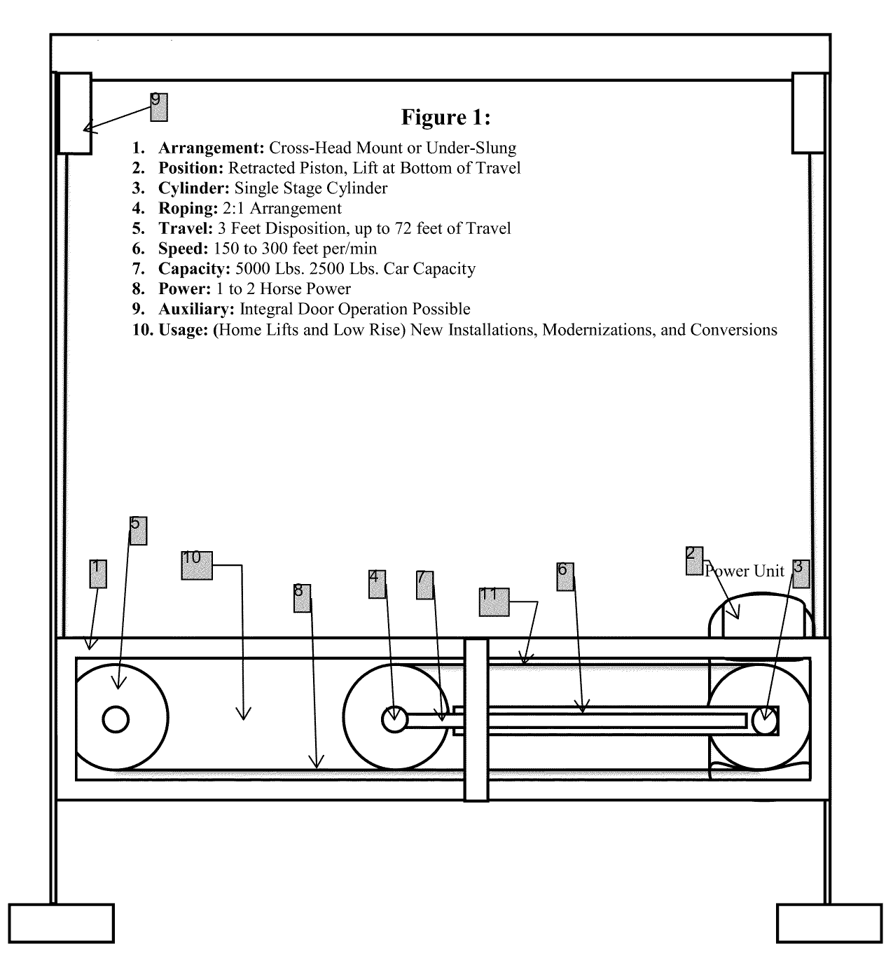

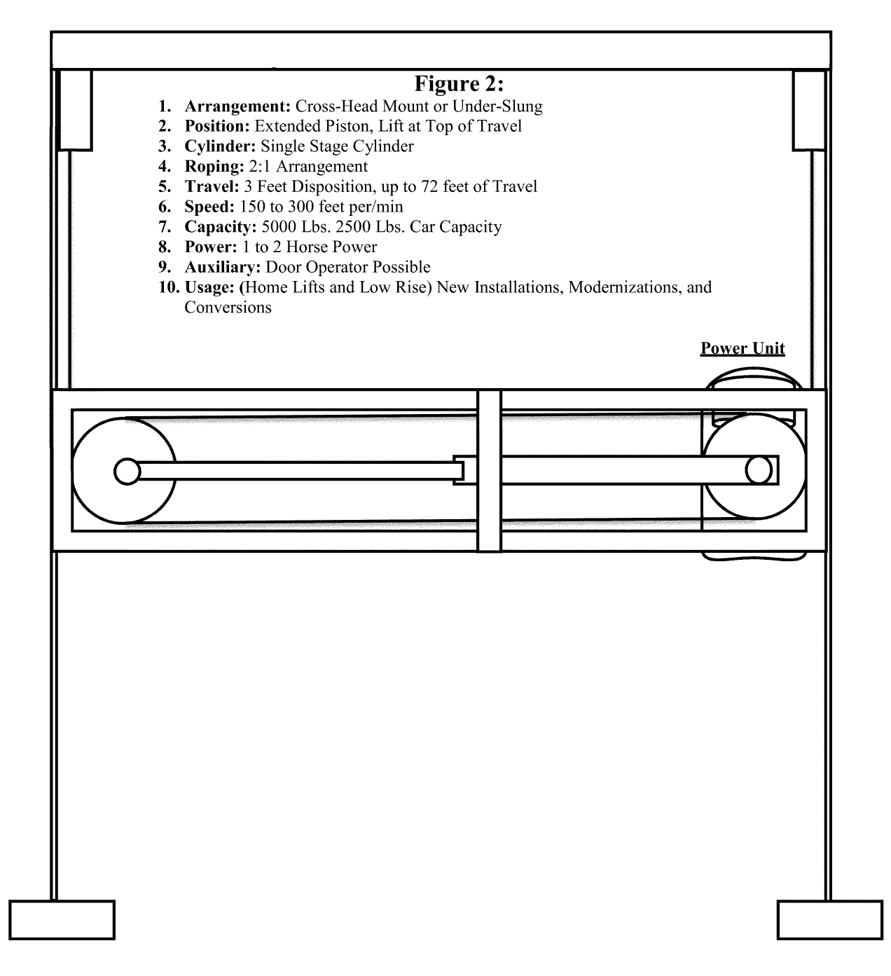

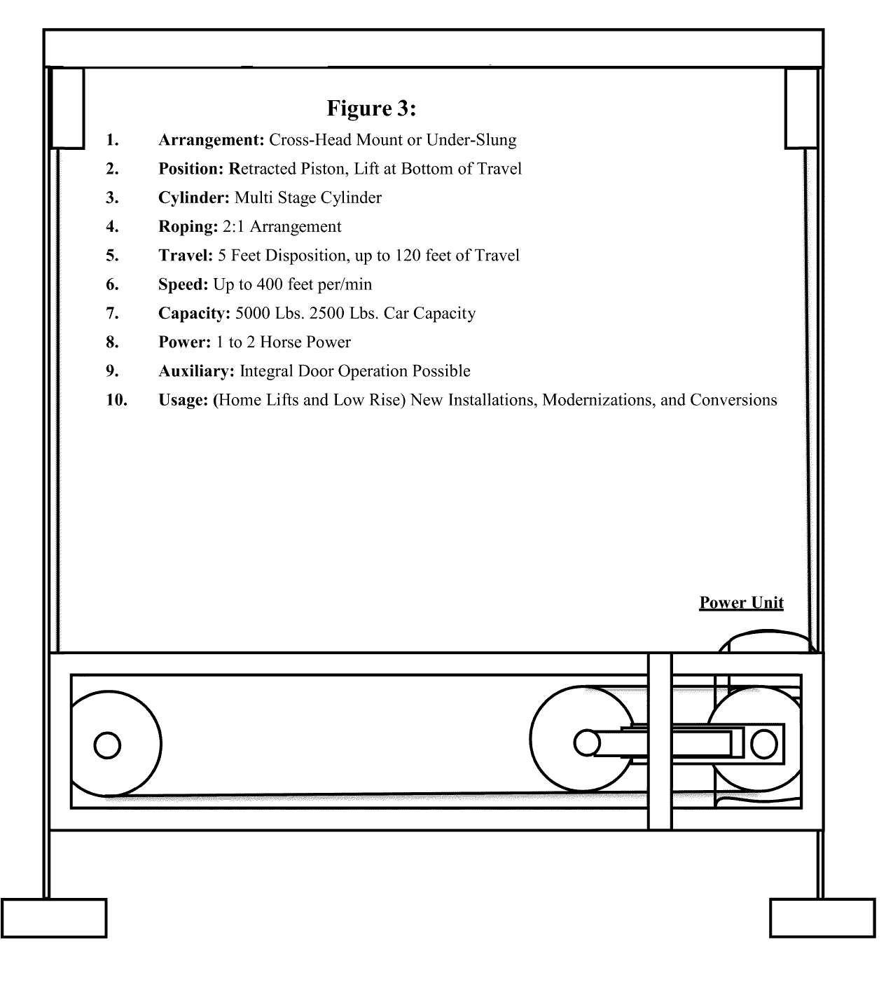

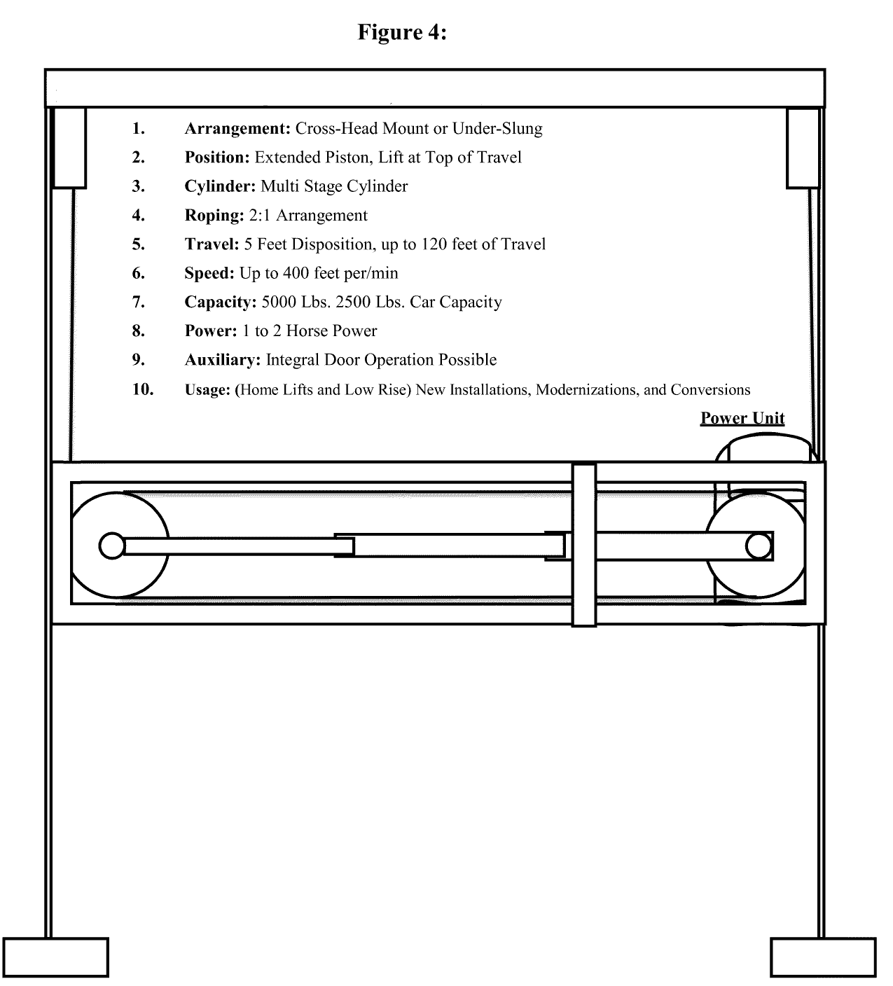

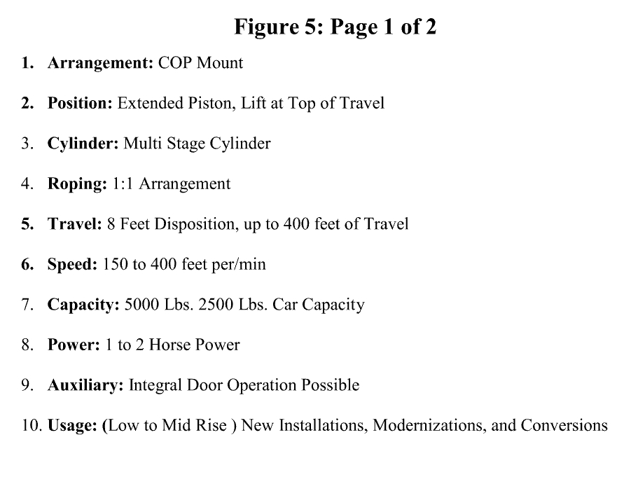

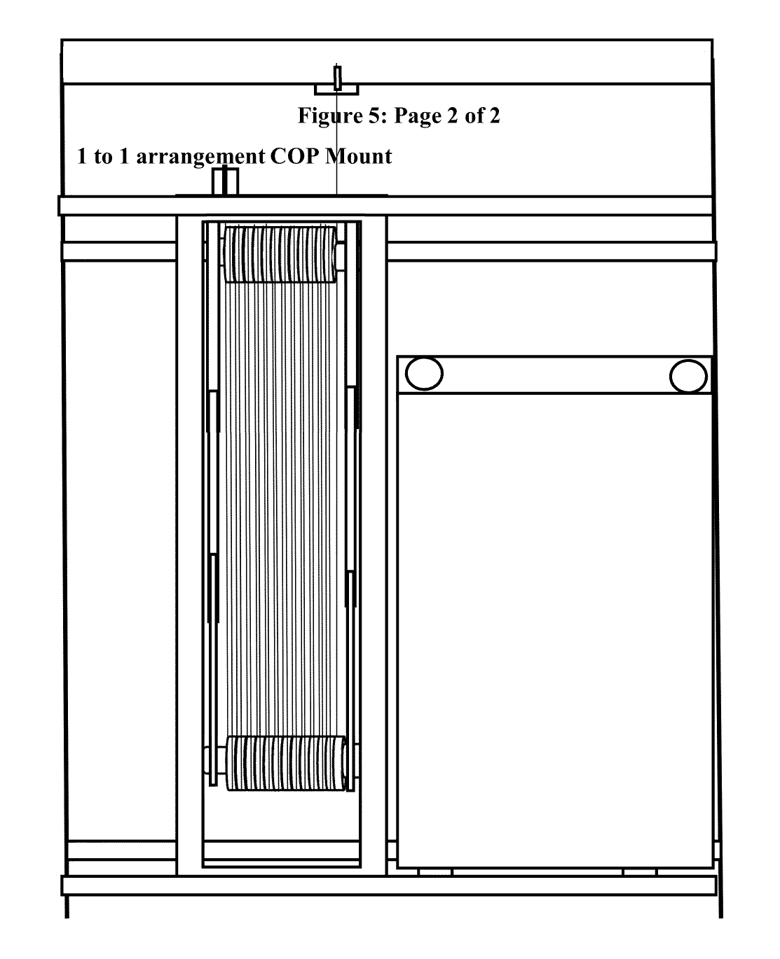

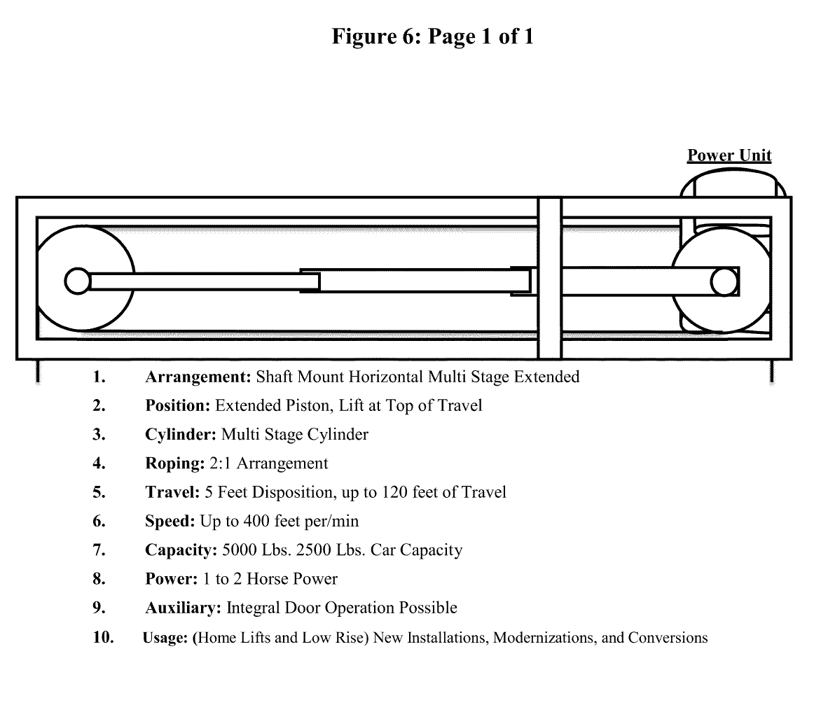

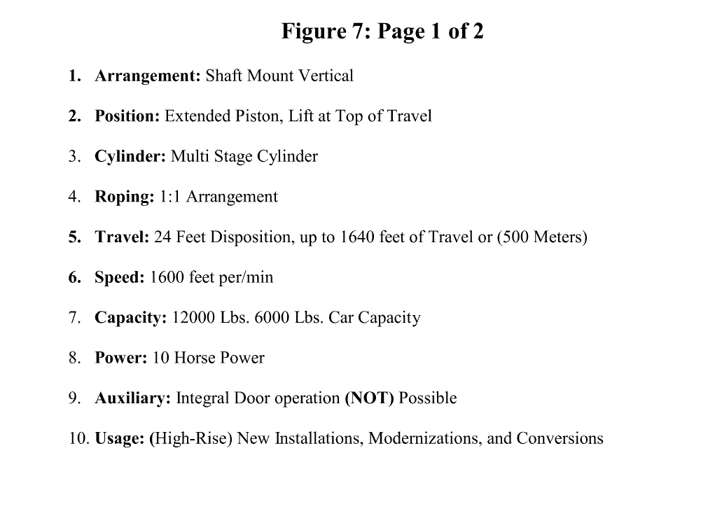

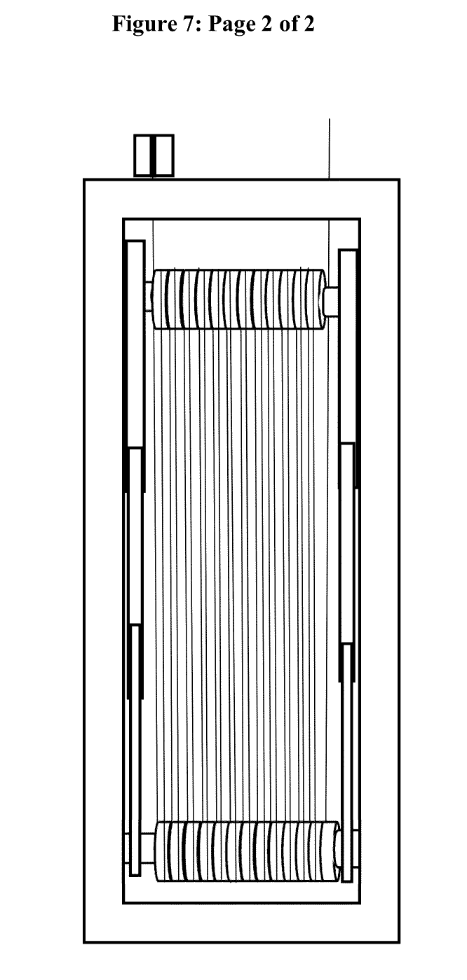

In FIG. 1 the machine consists of a pair of joined spaced steel channeled frame members 1, for its housing which contains all apparatus of its embodiment.

An Integrated Power Unit 2, in which to raise the car, or operate the doors; power is applied to the linear actuators in a manner which is well known and therefore need not be described further in its description.

A Bridle Cable Reel 3, attached to the Frame 1, containing the Bridled Sheaves 3, which is fixed at its position, and serves as a block that makes up the fixed end of the lift and serves as half of the 2:1 suspension, deflection, and cable alignment.

A Harnessed Cable Reel 4, attached to the Piston 7, containing the Harness sheaves in middle, on a variable shaft at its positions, and serves as a lift block for raising and lowering the lift, such as an inverse block and tackle arrangement.

A Deflector Sheave 5, attached to the Frame 1, at opposite end of channel, which is fixed at its position, and serves as deflection, cable alignment, and the opposite half of the 2:1 suspension.

A Linear Actuator 6, attached to the Frame 1, the Bridle Reel 3, and the Harness 4, serves as a linear force for extending and retracting the Harness 4, thru the length of travel, thus raising and lowering the lift between floors. The cylinder housing is secured to the Bridle Cable Reel 3, at one end and bracketed at the head end to the machine's housing 1. The piston 7 is connected to the Harness Cable Reel 4, for extending and retracting the length of travel thus raising and lowering the lift between floors.

The Suspension Mass 8 is attached to the Bridle Sheave 3, and Deflector Sheave 5, in which the lift is suspended on its cables at top of Rails 9.

The Hoisting area 10, from Bridle to Deflectors position 3, and 5, which contains the Hoisting Mass 11, and contains the Stroke or total Length of Travel also 11, and serves as the hoisting means of raising and lowering the lift between floors.

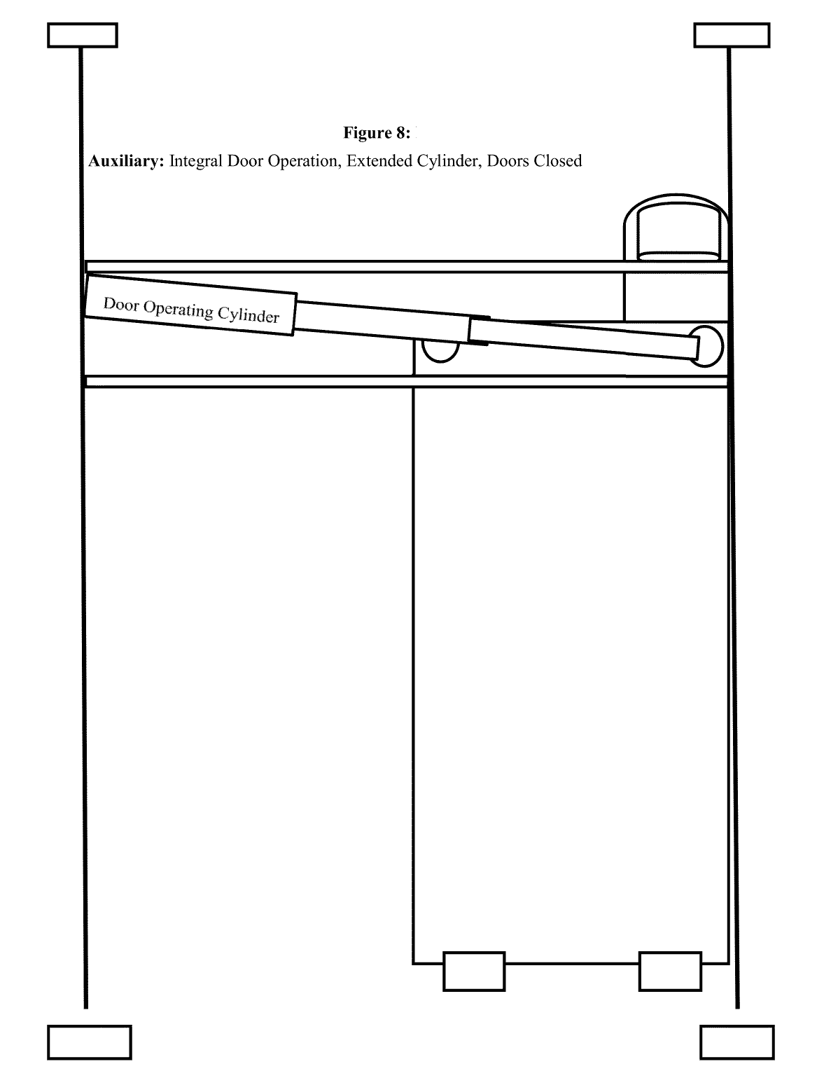

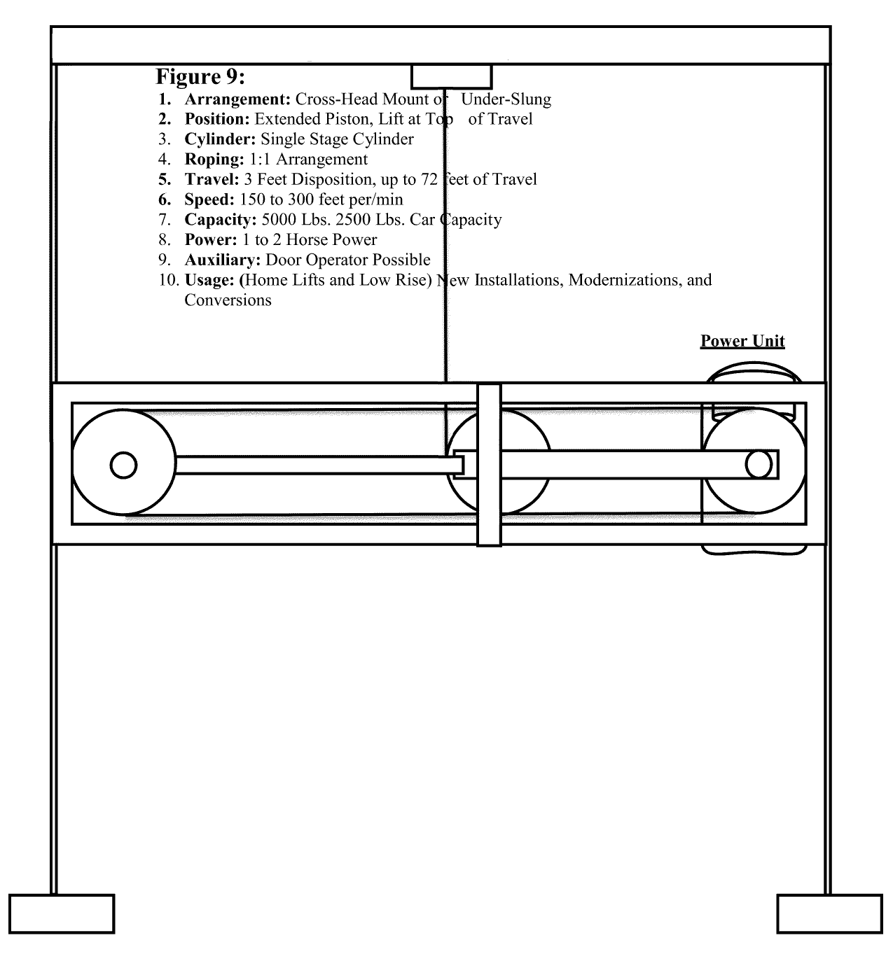

In FIG. 8 an optional auxiliary Linear Actuator 12, with linear or rotor motion “(Car Top Arraignment Only)”, attached to the Frame 1, and the Door Header 13, and serves as a Door Operating Device for the opening and closing of the Elevator Car Doors thus, eliminating the needs for additional motors and door operators.

OPERATION NOTE 2: (Only Hydraulic Power is Shown to Reduce Redundancy) In sequence to operation; Linear Motion is achieved by applying power to actuator/s 6, extending the pistons causing sheaves and cable movement inside in the Hoisting Mass 11, thus causing the car to move upwardly by a minimum 12:1 ratio, or 1″ inch of machine movement for every 12's of hoisting cable movement, as well as increasing the car speed at a 12:1 ratio to cylinder speed; resulting in actually raising the elevator at a rate of 196 feet/minute, while piston movements is only 196 inches/minute. The car lowering process is achieved by the picking of electric valves allowing fluid to vent from the actuators/s and the cars gravity causes the car to descend by pushing the actuators 7, inwardly, causing retraction in the hoisting mass 11, thus expelling hydraulic fluid from the cylinder, thus lowering the elevator on its own weight back thru the valves.

Characteristics of the Machine:

Easy and Diverse Mounting Arrangements: COP, Cross-Head, Shaft-Horizontal, or Vertical, and Under-Slung,

Cylinders: Single, or Multi Stage Cylinders,

Roping: 1:1, or 2:1 Arrangement,

Travel: 3 to 30 Feet Disposition, up to 3300 feet of Travel,

Speed: up to feet 3000 per/min,

Gross load Capacities: up to 33000 Lbs.

Power: 1 to 20 Horse Power,

Options: Door Operator Possible with COP and Cross-Head Mounting Arrangements,

Usage: Home Lifts, to High Rise Applications.

1. A Linear Motion Elevator Suspension Machine, according to this claim and all parts of Application, Specifications, Drawings, and Claims to its embodiment; it lifts a vertically travelling elevator, and includes an integrated power unit. Comprising of multiple wraps of cable, through multiple sheaves, on two separate reels, and a linear actuator capable of pushing the reels apart for raising the elevator and bringing the reels together for lowering the elevator. A “Linear Motion Elevator Suspension Machine” in which motion is achieved using Linear Mechanical Actuators, a mechanical device that converts energy to power from air, electricity or liquid, creating motion in a straight line; and is used in this application as a force for lifting a vertically travelling elevator. The machine is a single compact unit of multiple mounting arrangements that can be mounted at the bottom or top of the elevator car, in the pit or overhead of the shaft. The single compact unit can be applied integral to the Car Operating Panel (COP), Crosshead or Bolster Plank, with the hoisting cables attached and dead ended at top of rails for a 1:1 or 2:1 configuration. OPERATION NOTE 2: (Only Hydraulic Power is Shown to Reduce Redundancy) In sequence to its operation Linear Motion is achieved by applying power to actuator/s 6, extending the pistons causing sheaves and cable movement inside the Hoisting Mass 11, causing the car to move upwardly by a minimum 12:1 ratio, or 1″ inch of machine movement for every 12's of hoisting cable movement, as well as increasing the car speed at a 12:1 ratio to cylinder speed; resulting in actually raising the elevator at a rate of 196 feet/minute with piston movements of only 196 inches/minute. The car lowering process is achieved by the picking of electric valves allowing fluid to vent from the actuator/s, and the cars gravity causes the car to descend by pushing the actuators 7, inwardly, causing retraction in the Hoisting Mass 11, and thus expelling hydraulic fluid from the cylinder, thus lowering the elevator on its own weight back thru the valves.
a) A Linear Motion Elevator Suspension Machine according to claim one, further comprising a “Channeled Framed Housing 1, multiple wraps of cable, through multiple sheaves, on two separate reels, and a linear actuator 6, capable of pushing the reels apart for raising the elevator and bringing the reels together for lowering the elevator.
b) A Linear Motion Elevator Suspension Machine according to claim 1, further comprising “Multiple Mounting Arrangements”, the machine being a single compact unit that can be mounted at the bottom or top of the elevator car, Car Operating Panel (COP), or in the pit, overhead, or on top of guide rails, or in the shaft.
c) A Linear Motion Elevator Suspension Machine according to claim 1, further comprising a “Bridle Cable Reel” 3, attached to the Frame, 1, containing the Bridled sheaves 3, which is fixed at its position, and serves as a block that makes up the fixed end of the lift and serves as half of the 2:1 suspension, deflection, and cable alignment.
d) A Linear Motion Elevator Suspension Machine according to claim 1, further comprising a “Harnessed Cable Reel” 4, attached to the Piston 7, containing the Harness sheaves in middle, on a variable shaft at its positions, and serves as a lift block for raising and lowering the lift, such as an inverse block and tackle arrangement.
e) A Linear Motion Elevator Suspension Machine according to claim 1, comprising a “Deflector Sheave” 5, attached to the Frame, 1, at opposite end of channel, which is fixed at its position, and serves as deflection, cable alignment, and the opposite half of the 2:1 suspension.
f) A Linear Motion Elevator Suspension Machine according to claim 1, comprising a “Linear Actuator/s” 7, attached to the Frame 1, of the Bridle Reel 3, and the Harness 4, serves as a linear force for extending and retracting the Harness Reel 4, thru the length of travel, thus raising and lowering the lift between floors. The cylinder housing is secured to the Bridle Cable Reel 3, at one end and bracketed at the head end to the machine's housing.
g) A Linear Motion Elevator Suspension Machine according to claim 1, comprising the “Suspension Cable Mass” 8, is attached to the Bridle 3, and Deflector Sheave 5, is the Hoisting area from Bridle to Deflectors 3, and 5, which contains the Hoisting Mass 11, and contains the Stroke or total Length of Travel 10, with its ends attached to the Guide Rails 9, at top, and serves in part as the Elevator Suspension, and the hoisting means of raising and lowering the lift between floors.

2. A Linear Motion Elevator Suspension Machine according to claim 1, further comprising an Integrated Power Unit” 2, comprising an Electric Motor, a Pump, and valve/s in order to raise the car, or operate the doors, power is applied to the linear actuators in a manner which is well known and therefore need not be described further in its description.

3. A Linear Motion Elevator Suspension Machine according to claims 1 and 2, further comprising an integral “Manual Lift Operating Port” that allows an elevator to be raised or lowered manually, (similar to that of a Hydraulic Bottle Jack) and used for inspection and emergency purposes.

4. A Linear Motion Elevator Suspension Machine according to claims 1 and 2, further comprising an “Auxiliary Actuator” 12, with linear or rotor motion “(Car Top Arraignment Only)”, attached to the Frame 1, and the Door Header 13, and serves as a Door Operating Device for the opening and closing of the Elevator Car Doors thus, eliminating the needs for additional motors and door operators.

5. A Linear Motion Elevator Suspension Machine according to claims 1 and 2, further comprising an “Extended Stroke Roping Scheme” in which an elevator is roped setting on its buffers at bottom floor, with the piston extended, minus the required “Total Length of Travel”, causing the cylinder to bypass, in respect to Code Requirements at the required distance of over travel at top floor. Although applicable to any length cylinder; an “Example Design” allows a 36″ inch cylinder to serve a range of travel heights from 8′ feet to 72′ feet of travel, wherefore, eliminating the need for re-engineering a Machine for every different application of travel height.
